(19) United States
(12) Patent Application Publication
(10) Pub. No.: US 2026/0244369 A1
(43) Pub. Date: Aug. 20, 2026

(54) INFORMATION PROCESSING SYSTEM, INFORMATION PROCESSING APPARATUS, AND NON-TRANSITORY COMPUTER READABLE MEDIUM

(71) Applicant: FUJIFILM Business Innovation Corp., Tokyo (JP)

(72) Inventor: Xiongfan JIN, Kanagawa (JP)

(73) Assignee: FUJIFILM Business Innovation Corp., Tokyo (JP)

(21) Appl. No.: 19/310,019

(22) Filed: Aug. 26, 2025

(30) Foreign Application Priority Data
Feb. 14, 2025 (JP) 2025-022699

(51) Int. Cl. G06F 3/12

(52) U.S. Cl. CPC G06F 3/1204; G06F 3/1239; G06F 3/1287

(57) ABSTRACT

An information processing system includes: a first processor included in each of one or more processing execution apparatuses configured to execute processing in accordance with an instruction from a user; a second processor included in each of one or more information processing apparatuses to be used when the user instructs the one or more processing execution apparatuses to execute processing; and a third processor included in an information management apparatus configured to manage restriction information related to a restriction on a use of the one or more processing execution apparatuses by the user, in which the first processor and the second processor are each configured to acquire the restriction information from the information management apparatus at a predetermined timing and respectively cause a corresponding processing execution apparatus among the one or more processing execution apparatuses and a corresponding information processing apparatus among the one or more information processing apparatuses to hold the restriction information, and the second processor is configured to: acquire the restriction information held by each of the one or more processing execution apparatuses when the information management apparatus is not accessible in accordance with an operation of the user; and cause the restriction information held by the corresponding information processing apparatus and by each of the one or more processing execution apparatuses to be updated with latest restriction information selected from the restriction information held by the corresponding information processing apparatus and the restriction information acquired from each of the one or more processing execution apparatuses.

### CROSS-REFERENCE TO RELATED APPLICATIONS

This application is based on and claims priority under 35 USC 119 from Japanese Patent Application No. 2025-022699 filed Feb. 14, 2025.

### BACKGROUND

### (i) Technical Field

The present disclosure relates to an information processing system, an information processing apparatus, and a non-transitory computer readable medium.

### (ii) Related Art

To implement printing in a system environment where a print server is not installed in an office or printing to any output destination, the use of a cloud print service is widely spread. In the use of the cloud print service, once a user registers a print job in a print server provided in a cloud through an information processing apparatus such as a personal computer (PC), the user is able to select a print timing and a printer to be an output destination.

To provide the cloud print service, a restriction on the service may be set for each user depending on a contract fee or the like. For example, as a restriction, an upper limit is set for the number of sheets printable in a predetermined period such as one month. In this case, the print server manages the printable number of sheets for each user. More specifically, having executed printing using the cloud print service in accordance with an instruction from a user, the printer notifies the print server of the number of sheets printed by this printing. In accordance with the notification of the number of printed sheets, the print server subtracts the managed counter for the printable number of sheets for the user, and performs management, when the counter reaches 0, so that the printing based on a request from the user is not executed.

Examples of the related art include Japanese Unexamined Patent Application Publication No. 2004-102356 and Japanese Unexamined Patent Application Publication No. 2015-053731.

### SUMMARY

In a case where the restriction on the use of a processing execution apparatus by a user is managed on the basis of restriction information managed by an information management apparatus, if the information management apparatus becomes inaccessible, there may occur an inconvenience such as disabling the restriction on the use of the processing execution apparatus.

For example, in the above-described related art, the print server (the information management apparatus) manages the printable number of sheets (the restriction information) for printing by the printer (the processing execution apparatus), but such management of the printable number of sheets is disabled.

Aspects of non-limiting embodiments of the present disclosure relate to, in a case where the restriction on the use of the processing execution apparatus by a user is managed based on the restriction information managed by the information management apparatus, even if the information management apparatus becomes inaccessible, preventing an inconvenience from occurring in the use of the processing execution apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a first processor included in each of one or more processing execution apparatuses configured to execute processing in accordance with an instruction from a user; a second processor included in each of one or more information processing apparatuses to be used when the user instructs the one or more processing execution apparatuses to execute processing; and a third processor included in an information management apparatus configured to manage restriction information related to a restriction on a use of the one or more processing execution apparatuses by the user, in which the first processor and the second processor are each configured to acquire the restriction information from the information management apparatus at a predetermined timing and respectively cause a corresponding processing execution apparatus among the one or more processing execution apparatuses and a corresponding information processing apparatus among the one or more information processing apparatuses to hold the restriction information, and the second processor is configured to: acquire the restriction information held by each of the one or more processing execution apparatuses when the information management apparatus is not accessible in accordance with an operation of the user; and cause the restriction information held by the corresponding information processing apparatus and by each of the one or more processing execution apparatuses to be updated with latest restriction information selected from the restriction information held by the corresponding information processing apparatus and the restriction information acquired from each of the one or more processing execution apparatuses.

### BRIEF DESCRIPTION OF THE DRAWINGS

Exemplary embodiments of the present disclosure will be described in detail based on the following figures, wherein:

FIG. 1 is a block diagram illustrating the entire configuration of an information processing system according to the exemplary embodiment;

FIG. 2 is a diagram illustrating an example of a data configuration of restriction information stored in a restriction information storage unit according to the exemplary embodiment;

FIG. 3 is a flowchart illustrating print processing according to the exemplary embodiment;

FIG. 4A is a sequence diagram illustrating processing in a normal print mode according to the exemplary embodiment;

FIG. 4B is a sequence diagram following FIG. 4A;

FIG. 5A is a sequence diagram illustrating processing in a local print mode according to the exemplary embodiment; and

FIG. 5B is a sequence diagram following FIG. 5A.

### DETAILED DESCRIPTION

Exemplary embodiments of the present disclosure will be described below with reference to the drawings.

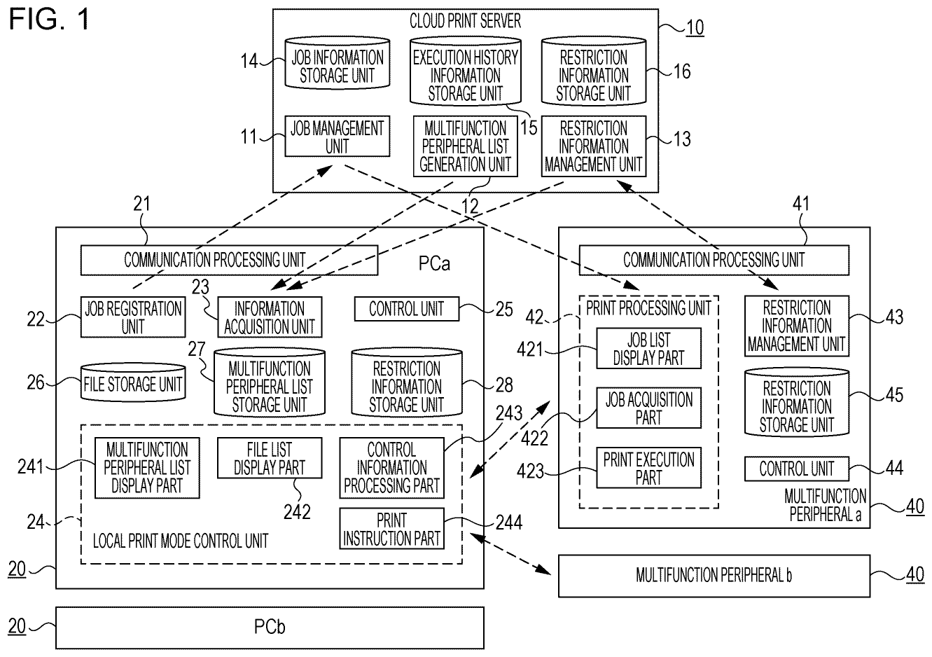

FIG. 1 is a block diagram illustrating the entire configuration of an information processing system according to the exemplary embodiment. Since the information processing system according to the exemplary embodiment is configured to be able to provide a cloud print service, the information processing system may be referred to as a cloud print service system. In the use of the cloud print service, if a print job is registered in a cloud print server 10 provided in a cloud, a user is able to select a print timing and a printer as an output destination. In the exemplary embodiment, printing using the cloud print service is referred to as “cloud printing”.

FIG. 1 illustrates the cloud print server 10, a PC 20, and a multifunction peripheral 40. The apparatuses 10, 20, and 40 are connected to a network (not illustrated) such as the Internet, for example, and are mutually communicable.

The cloud print server 10 provides a cloud print service to a user of the PC 20 or the multifunction peripheral 40. The cloud print server 10 may be implemented with the hardware configuration of a general-purpose server computer. That is, the cloud print server 10 includes a central processing unit (CPU) as a third processor, a read only memory (ROM), a random access memory (RAM), a hard disk drive as a storage unit, and a network interface provided as a communication unit.

The cloud print server 10 manages a print job received from the PC 20. In a case where push printing is requested, the cloud print server 10 issues an output instruction directly to the designated multifunction peripheral 40. In a case where pull printing is requested, the cloud print server 10 stores the print job until the cloud print server 10 is requested to issue the output instruction.

The cloud print server 10 includes a job management unit 11, a multifunction peripheral list generation unit 12, a restriction information management unit 13, a job information storage unit 14, an execution history information storage unit 15, and a restriction information storage unit 16. Note that the components not used in the description of the exemplary embodiment are omitted from the drawings.

The job management unit 11 manages information of jobs to be executed in the cloud print service. More specifically, the job management unit 11 performs management such as the registration of information of jobs transmitted from the PC 20 in the job information storage unit 14 and the deletion of executed jobs. In accordance with a request from the multifunction peripheral 40, the job management unit 11 transmits a list of print jobs registered by the requesting user (hereinafter, simply referred to as a “job list”), or transmits a job selected from the job list.

In accordance with a transmission request from a user using the PC 20, the multifunction peripheral list generation unit 12 searches the execution history information storage unit 15 to generate a list of multifunction peripherals 40 (hereinafter, referred to as a “multifunction peripheral list”) satisfying a predetermined condition such as a predetermined number (e.g., 10) or less of multifunction peripherals 40 used most recently by the user or multifunction peripherals 40 used within a predetermined period, and returns the list to the requesting PC 20.

The restriction information management unit 13 manages restriction information related to a restriction on the use of the multifunction peripheral 40 by a user. The exemplary embodiment will be described using an example in which an upper limit is set for the number of sheets printable by a user of the cloud print service within a predetermined period, such as a month, (hereinafter, referred to as the “printable number of sheets”) as the restriction information.

The job information storage unit 14 stores job information that is information of jobs. The data configuration itself of the job information may be the same as the conventional configuration, and the job information includes, for example, a job ID as identification information of a job, a job owner, job registration time information, and the entity of a job.

The execution history information storage unit 15 stores information related to the execution history of jobs stored in the job information storage unit 14. More specifically, the execution history information includes a job ID, a job owner, job execution start time information, time required for execution, the PC 20 having given an execution instruction, the multifunction peripheral 40 having executed a job, and the like.

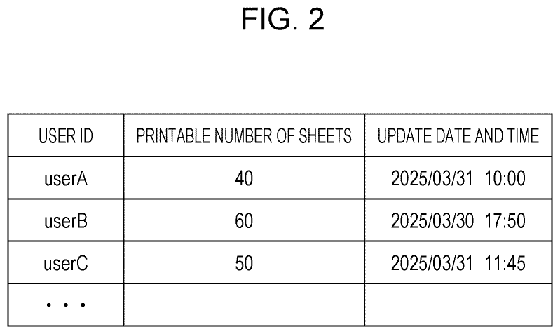

FIG. 2 is a diagram illustrating an example of the data configuration of the restriction information stored in the restriction information storage unit 16 according to the exemplary embodiment. The restriction information is set for each user, and includes a user ID as identification information of the user, associated with the content of restriction information, the content being, in the exemplary embodiment, the currently printable number of sheets and time information indicating the latest update time point of the printable number of sheets (hereinafter, referred to as “update date and time”).

A cloud print driver provided in the PC 20 allows the PC 20 to use the cloud print service. The PC 20 may be implemented by a general-purpose hardware configuration. That is, the PC 20 includes a CPU as a second processor, a ROM, a RAM, a hard disk drive as a storage unit, a network interface provided as a communication unit, and a user interface including an input unit such as a mouse and a keyboard and a display unit such as a display.

While two PCs 20 are illustrated in FIG. 1 for the sake of convenience, this indicates that the information processing system may include a plurality of PCs 20 as the information processing apparatuses. In the exemplary embodiment, the PC 20 is an example of the information processing apparatus used by a user who instructs the multifunction peripheral 40 to execute processing of cloud printing. Therefore, the information processing apparatus is not necessarily limited to the PC 20 as long as it is capable of giving an instruction to the multifunction peripheral 40, and may be, for example, a portable terminal such as a tablet terminal. Each PC 20 may have the same configuration, and thus FIG. 1 illustrates the components of one PC a. When the two PCs 20 illustrated in FIG. 1 do not need to be distinguished from each other, they are referred to as “PC 20”, while when they need to be distinguished from each other, they are referred to as “PC a” or “PC b”.

The PC 20 includes a communication processing unit 21, a job registration unit 22, an information acquisition unit 23, a local print mode control unit 24, a control unit 25, a file storage unit 26, a multifunction peripheral list storage unit 27, and a restriction information storage unit 28. Note that the components not used in the description of the exemplary embodiment are omitted from the drawings.

The communication processing unit 21 performs communication processing with the cloud print server 10 via a network. When the communication processing unit 21 is not able to normally communicate with the cloud print server 10, such as when the access to the cloud print server 10 in accordance with user's operation is not possible, for example, the communication processing unit 21 detects this inaccessible state as a communication error. Note the inaccessible state occurs due to not only the disconnection of a network but also various causes such as the downtime of the cloud print server 10.

In accordance with a user's instruction, the job registration unit 22 generates a print job for printing a file selected as a print target from files stored in the file storage unit 26, and transmits the print job to the cloud print server 10 for registration. The information acquisition unit 23 acquires a multifunction peripheral list and restriction information by requesting them from the cloud print server 10, and registers the multifunction peripheral list and the restriction information in the multifunction peripheral list storage unit 27 and the restriction information storage unit 28, respectively.

Assuming that the system state allowing the multifunction peripheral 40 to perform printing using the cloud print service is referred to as a normal print mode, a term “local print mode” is used in the exemplary embodiment to refer to a state in which when the cloud print service is not available due to a failure such as network interruption between the multifunction peripheral 40 and the cloud print server 10, that is, when the above-described communication error has occurred, the multifunction peripheral 40 is caused to execute printing without using a network.

The local print mode control unit 24 controls the execution of printing when the PC 20 is in the local print mode. The local print mode control unit 24 includes a multifunction peripheral list display part 241, a file list display part 242, a control information processing part 243, and a print instruction part 244. The multifunction peripheral list display part 241 displays a multifunction peripheral list stored in the multifunction peripheral list storage unit 27. The file list display part 242 displays a list of files stored in the file storage unit 26 as candidates for a file to be printed. The control information processing part 243 performs processing related to the restriction information, such as the request for restriction information transmission to the multifunction peripheral 40, the transmission of restriction information to the multifunction peripheral 40, and the update of set contents of the restriction information. The print instruction part 244 instructs the multifunction peripheral 40 to execute printing by transmitting a print job including a file selected as a print target to the multifunction peripheral 40.

The control unit 25 controls and coordinates the operation of the components 21 to 24 included in the PC 20 so as to execute printing in the local print mode that is characteristic of the exemplary embodiment.

The file storage unit 26 stores files that are candidates for a print target. The multifunction peripheral list storage unit 27 stores the multifunction peripheral list acquired from the cloud print server 10 by the information acquisition unit 23. The restriction information storage unit 28 stores the restriction information acquired from the cloud print server 10 by the information acquisition unit 23.

Print Agent installed in the multifunction peripheral 40 allows the multifunction peripheral 40 to use the cloud print service. The multifunction peripheral 40 is an image forming apparatus that has various functions such as a printing function, a copying function, and a scanner function, and includes therein an information processing apparatus. The multifunction peripheral 40 may be implemented by a hardware configuration of a general-purpose multifunction peripheral. That is, the multifunction peripheral 40 includes a CPU as a first processor, a ROM, a RAM, a hard disk drive as a storage unit, a network interface provided as a communication unit, an operation panel as a user interface, a scanner, and a printer.

In the exemplary embodiment, the multifunction peripheral 40 is an example of the processing execution apparatus that executes processing of cloud printing in accordance with an instruction from a user. While two multifunction peripherals 40 are illustrated in FIG. 1 for the sake of convenience, this indicates that the information processing system may include a plurality of multifunction peripherals 40 as the processing execution apparatuses. The processing execution apparatus is not necessarily limited to the multifunction peripheral 40 as long as it is capable of executing cloud printing in accordance with an instruction from a user, and may be, for example, a printer in which Print Agent is installable. Each multifunction peripheral 40 may have the same configuration, and thus FIG. 1 illustrates the components of one multifunction peripheral a. When the two multifunction peripherals 40 illustrated in FIG. 1 do not need to be distinguished from each other, they are referred to as “multifunction peripheral 40”, while when they need to be distinguished from each other, they are referred to as “multifunction peripheral a” or “multifunction peripheral b”.

The multifunction peripheral 40 includes a communication processing unit 41, a print processing unit 42, a restriction information management unit 43, a control unit 44, and a restriction information storage unit 45. Note that the components not used in the description of the exemplary embodiment are omitted from the drawings.

The communication processing unit 41 performs communication processing with the cloud print server 10 via a network. When the communication processing unit 41 is not able to normally communicate with the cloud print server 10, such as when the access to the cloud print server 10 for acquisition of a print job or restriction information is not possible, for example, the communication processing unit 41 detects this inaccessible state as a communication error.

The print processing unit 42 exerts the print function to execute print processing. The print processing unit 42 includes a job list display part 421, a job acquisition part 422, and a print execution part 423. In the normal print mode, the job list display part 421 acquires a list of print jobs registered by a user, that is, a job list, from the cloud print server 10 in accordance with an instruction from the user, and displays the job list on the operation panel. The job acquisition part 422 acquires, from the cloud print server 10, a print job selected by the user from the job list. The print execution part 423 executes a print job acquired by the job acquisition part 422 in the normal print mode. Moreover, the print execution part 423 executes a print job transmitted from the PC 20 in the local print mode.

The restriction information management unit 43 manages restriction information set in the restriction information storage unit 45 of the multifunction peripheral 40. For example, as will be described in detail below, the restriction information management unit 43 acquires the restriction information from the cloud print server 10 at a predetermined timing, such as when a print job is acquired, and registers the restriction information in the restriction information storage unit 45, or acquires the number of sheets required for printing in the print processing executed by the print processing unit 42 and updates the printable number of sheets set in the restriction information storage unit 45.

The control unit 25 controls and coordinates the operation of the components 41 to 43 included in the multifunction peripheral 40 so as to implement the printing function of the multifunction peripheral 40, particularly the printing in the local printing mode in the exemplary embodiment.

As described above, the restriction information storage unit 45 stores the restriction information acquired by the restriction information management unit 43 from the cloud print server 10. The data configuration of the restriction information is the same as that of the restriction information managed by the cloud print server 10, and includes a user ID associated with the currently printable number of sheets and update date and time for each user. The restriction information stored and managed in the multifunction peripheral 40 is updated in accordance with the print processing executed in the multifunction peripheral 40.

While in the exemplary embodiment, the restriction information is associated with each user, the present disclosure is not limited thereto, and the restriction information may be associated with each user group or may be for the entire system.

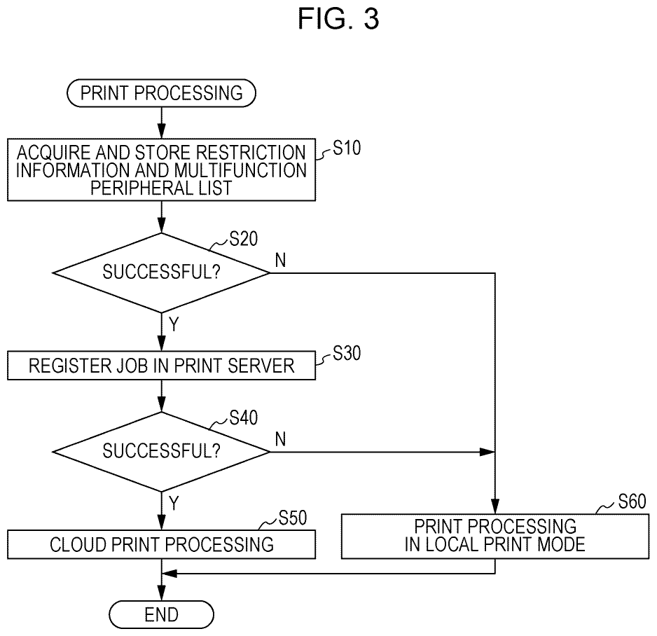

A schematic flow of the print processing performed in the exemplary embodiment will be described with reference to the flowchart illustrated in FIG. 3. FIG. 3 focuses on the processing performed by the PC 20.

The PC 20 needs to acquire the multifunction peripheral list and the restriction information from the cloud print server 10 at a predetermined timing. For example, it is assumed that the predetermined timing is the time of login to the PC 20. In this case, once a user logs in the PC 20, the information acquisition unit 23 acquires, from the cloud print server 10, the multifunction peripheral list and the restriction information associated with the logged-in user. While the communication processing unit 21 performs network communication with the cloud print server 10 to acquire various kinds of information from the cloud print server 10, the communication processing unit 21 is unable to acquire various kinds of information in a state where the network is interrupted. In this case (N at step S20), the control unit 25 shifts the PC 20 to the local print mode, so that the PC 20 performs print processing in the local print mode (step S60). Meanwhile, when various kinds of information are successfully acquired (Y at step S20), the control unit 25 causes the PC 20 to operate in the normal print mode. That is, the information acquisition unit 23 registers and stores the multifunction peripheral list in the multifunction peripheral list storage unit 27 and the restriction information in the restriction information storage unit 28 (step S10).

Next, once the user selects a file to be printed from the files in the file storage unit 26, the job registration unit 22 generates a print job for printing the file, and uploads the print job to the cloud print server 10. In this manner, the print job is registered in the cloud print server 10 (step S30).

While the communication processing unit 21 performs network communication with the cloud print server 10 to register a job in the cloud print server 10, the communication processing unit 21 is unable to transmit the print job in a state where the network is interrupted. In this case (N at step S40), the print processing is performed in the local print mode (step S60). Meanwhile, when the print job is successfully registered (Y at step S40), the cloud print processing can be performed (step S50).

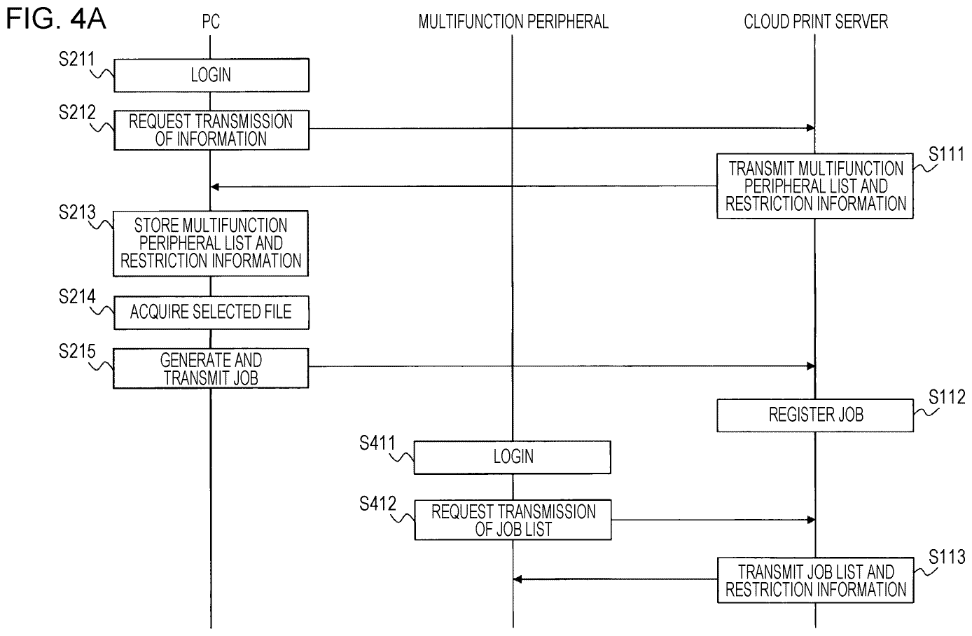

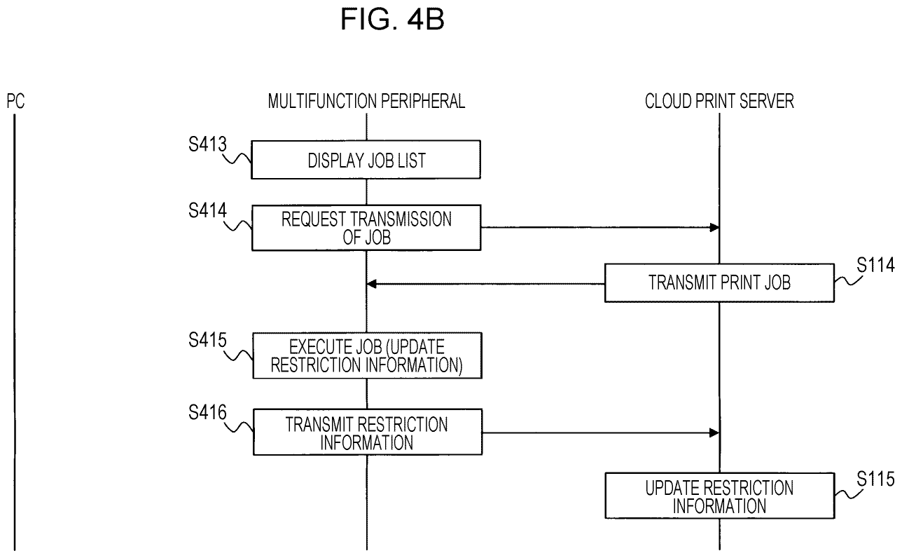

The overview of the print processing according to the exemplary embodiment is as described above. The details of the cloud print processing performed in the normal print mode according to the exemplary embodiment will be described with reference to the sequence diagrams illustrated in FIGS. 4A and 4B.

Once the user logs in the PC 20, the information acquisition unit 23 requests the cloud print server 10 to transmit the multifunction peripheral list and the restriction information associated with the logged-in user (step S212). The information transmission request includes a user ID of the logged-in user. The communication processing unit 21 transmits the information transmission request made by the information acquisition unit 23 to the cloud print server 10.

In the normal print mode, the network communication can be performed normally. Therefore, the cloud print server 10 is able to receive the information transmission request. In accordance with the information transmission request, the multifunction peripheral list generation unit 12 searches the execution history information storage unit 15 on the basis of the user ID included in the information transmission request to generate a list of multifunction peripherals 40 associated with the user, that is, a multifunction peripheral list, and transmits the multifunction peripheral list to the PC 20. The restriction information management unit 13 reads out, from the restriction information storage unit 16, the restriction information corresponding to the user ID included in the information transmission request, and transmits the restriction information to the PC 20 (step S111).

The information acquisition unit 23 stores the multifunction peripheral list acquired from the cloud print server 10 in the multifunction peripheral list storage unit 27 and the restriction information in the restriction information storage unit 28 (step S213).

Next, in order to perform printing using cloud printing, the user activates a predetermined cloud printing application used for instructing the multifunction peripheral 40 to execute printing. In the above description, the restriction information is acquired from the cloud print server 10 at the time of user login as the predetermined timing. Alternatively, the restriction information may also be acquired when the application is activated, that is, with the activation of the application as a trigger. It can also be considered that the job registration unit 22, the information acquisition unit 23, and the local print mode control unit 24 are implemented by the functions of this application.

The job registration unit 22 displays a plurality of files stored in the file storage unit 26 as candidates for a print target, so that a print target file is selected from the candidates. Upon acquiring the file selected by the user (step S214), the job registration unit 22 generates a print job for printing the file, and transmits the print job to the cloud print server 10 (step S215).

While a print job is preregistered in the cloud print server 10 in the cloud printing, as described above, the restriction information may be acquired from the cloud print server 10 at the time of this processing of registering the print job as the predetermined timing.

In the normal print mode, the network communication can be performed normally. Therefore, the cloud print server 10 is able to receive the print job. The job management unit 11 registers the print job transmitted from the PC 20 in the job information storage unit 14 (step S112).

In this manner, the user registers a print job in the cloud print server 10 as advance preparation for receiving the cloud print service.

Next, the user logs in the multifunction peripheral 40 for the cloud printing (step S411). Then, once the user selects the cloud print function through the operation panel, the job list display part 421 requests the cloud print server 10 to transmit a job list (step S412). This transmission request includes the user ID of the logged-in user. The communication processing unit 41 transmits the transmission request made by the job list display part 421 to the cloud print server 10.

In the normal print mode, the network communication can be performed normally. Therefore, the cloud print server 10 is able to receive the transmission request. In accordance with the transmission request, the job management unit 11 searches the job information storage unit 14 on the basis of the user ID included in the transmission request to generate a list of print jobs associated with the user, that is, a job list, and transmits the job list to the multifunction peripheral 40.

Similarly to the PC 20, the multifunction peripheral 40 also needs to acquire the restriction information from the cloud print server 10 at a predetermined timing and store the restriction information. For example, it is assumed that the predetermined timing is the time of acquiring a job list. In this case, the restriction information management unit 13 reads out, from the restriction information storage unit 16, the restriction information corresponding to the user ID included in the transmission request at the timing of receiving the job list transmission request, and transmits the restriction information to the multifunction peripheral 40 (step S113). Upon acquiring the job list from the cloud print server 10, the job list display part 421 displays the job list on the operation panel (step S413).

Subsequently, the user selects a print job to be executed from the job list. The job acquisition part 422 requests the cloud print server 10 to transmit the print job selected by the user (step S414). The transmission request includes the user ID of the logged-in user and a job ID associated with the selected print job. The communication processing unit 41 transmits the transmission request made by the job acquisition part 422 to the cloud print server 10.

In the normal print mode, the network communication can be performed normally. Therefore, the cloud print server 10 is able to receive the transmission request. In accordance with the transmission request, the job management unit 11 searches the job information storage unit 14 on the basis of the job ID included in the transmission request to acquire a print job, and transmits the print job to the multifunction peripheral 40 (step S114).

The multifunction peripheral 40 may acquire the restriction information before executing the print job. While in the above description, the predetermined timing is the time of acquiring a job list, the predetermined timing is not limited thereto. For example, the restriction information may be acquired from the cloud print server 10 at the time of acquiring a print job as the predetermined timing. Alternatively, the restriction information may be acquired in independent processing, that is, separately from the job list or the print job. Alternatively, similarly to the PC 20, the predetermined timing may be the time of user login.

Upon acquiring the print job from the cloud print server 10 in this manner, the print execution part 423 executes the acquired print job (step S415).

When the print job is executed, the multifunction peripheral 40 performs printing page by page. Every time one page is printed, the print execution part 423 notifies the restriction information management unit 43 of such printing. Every time the restriction information management unit 43 receives the notification, the restriction information management unit 43 updates the printable number of sheets in the restriction information associated with the user, which is set in the restriction information storage unit 45, to be subtracted by one. The printable number of sheets is information corresponding to a so-called counter. If the printable number of sheets reaches zero as a result of subtraction by one, the restriction information management unit 43 notifies the print execution part 423 of such a fact. Upon receiving this notification, the print execution part 423 restricts printing. That is, the print execution part 423 forcibly terminates the print job that is being executed. In this manner, the printable number of sheets for the user is restricted. The following description will be continued on the assumption that the number of printable sheets does not reach the restriction number.

As described above, while a print job is being executed, the printable number of sheets associated with the user, which is set in the restriction information storage unit 45, is sequentially updated. The update date and time are also sequentially updated together with the printable number of sheets. When the execution of the print job is finished, the restriction information management unit 43 transmits the restriction information associated with the user, which is set in the restriction information storage unit 45, to the cloud print server 10 through the communication processing unit 41 (step S416).

Upon receiving the restriction information from the multifunction peripheral 40, the restriction information management unit 13 of the cloud print server 10 overwrites and updates the restriction information set in the restriction information storage unit 16 with the received restriction information (step S115).

For example, it is assumed that when the printable number of sheets for a user A is 40 in the restriction information managed by the cloud print server 10, the multifunction peripheral a acquires the restriction information of the user A at the time of acquiring a print job. Note that the printable number of sheets included in the acquired restriction information is 40. It is assumed that the multifunction peripheral a has printed 10 sheets by executing the print job of the user A. In this case, the printable number of sheets for the user A held by the multifunction peripheral a becomes 30 (=40−10). After the execution of the print job, the cloud print server 10 is notified of the restriction information indicating that the printable number of sheets is 30, and overwrites and updates the restriction information set in the restriction information storage unit 16.

Thereafter, when the multifunction peripheral b acquires a print job to execute the print job of the user A, the printable number of sheets included in the acquired restriction information of the user A is 30.

In this manner, even when different multifunction peripherals 40 execute print jobs of the same user, it is possible to maintain the consistency of the printable number of sheets for the user. Since the restriction information includes the update date and time, it is possible to maintain the consistency even if the notification timing of the restriction information to the cloud print server 10 shifts.

For example, the restriction information held by the multifunction peripheral b is not updated with the restriction information transmitted from the multifunction peripheral a to the cloud print server 10 until the multifunction peripheral b acquires the restriction information at a predetermined timing, such as the time of acquiring a print job. Here, the multifunction peripheral b acquires the latest restriction information from the cloud print server 10 before executing a print job (step S113 in FIG. 4A), and thus the content of the restriction information set in the multifunction peripheral b is updated with the latest information.

However, strictly speaking, when a plurality of multifunction peripherals 40 simultaneously execute print jobs in parallel, an inconvenience may occur. For example, when the multifunction peripheral a notifies the cloud print server 10 of the restriction information indicating that the printable number of sheets is 30, and the multifunction peripheral b acquires the restriction information from the cloud print server 10 before the cloud print server 10 updates the restriction information storage unit 16 with the notified restriction information, the multifunction peripheral b acquires the restriction information indicating that the printable number of sheets is 40. In this case, if the multifunction peripheral b executes printing of 31 pages or more, an inconvenience may occur.

While the processing load and the network load may increase, the restriction information management unit 43 of the multifunction peripheral 40 may notify the restriction information management unit 13 of updated restriction information each time the printing of one page is finished, instead of notifying the cloud print server 10 of the restriction information each time the execution of a print job is finished, that is, in units of print jobs at step S416.

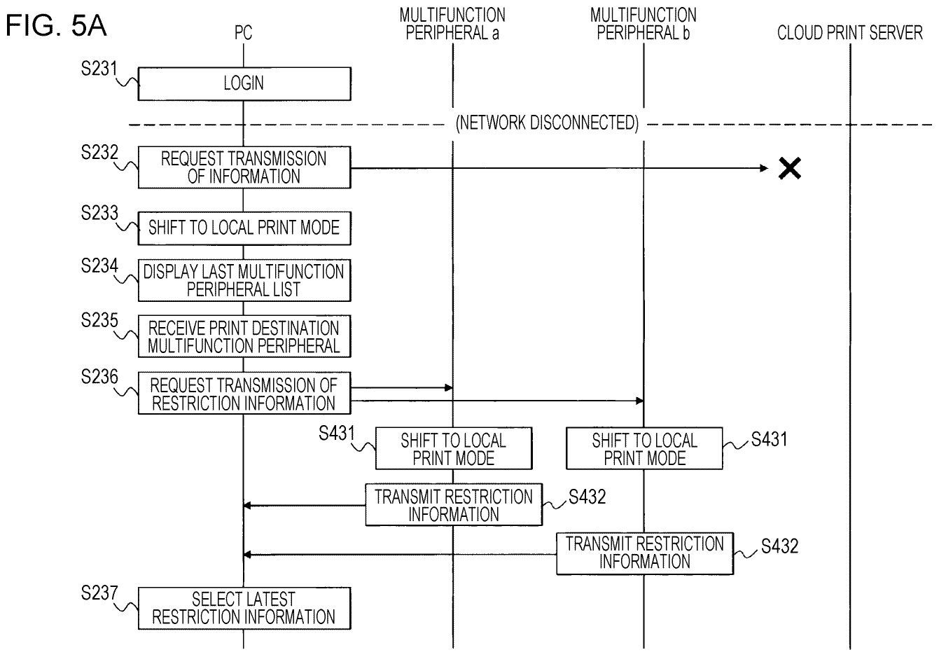

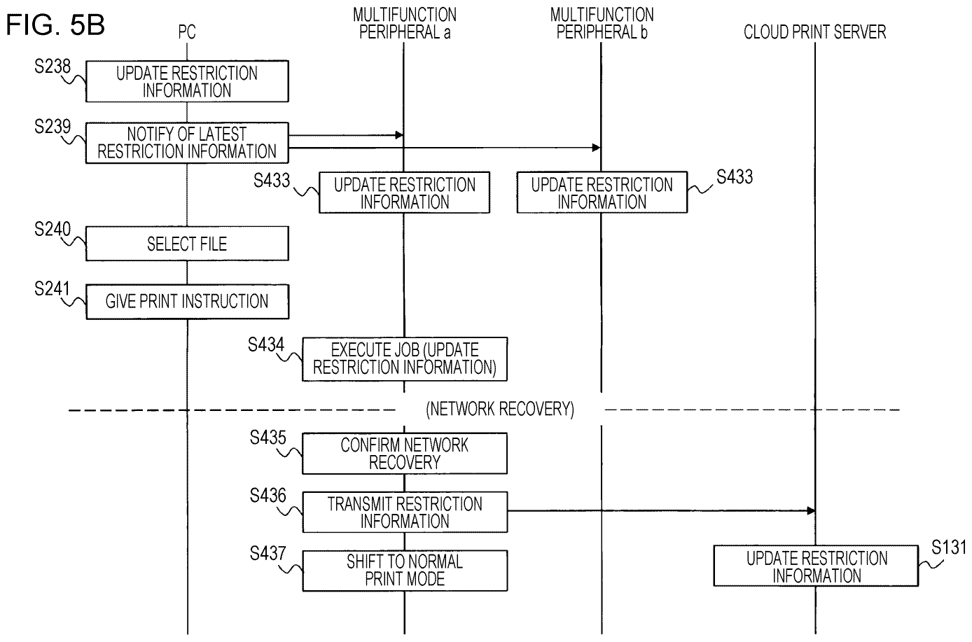

The print processing that is executed when the PC 20 and the multifunction peripheral 40 are unable to access the cloud print server 10, that is, the print processing in the local print mode, will be described with reference to sequence diagrams illustrated in FIG. 5A and B. The following description will be given assuming that a user is using the PC a.

Similarly to the case of the normal print mode, once the user logs in the PC a (step S231), the information acquisition unit 23 requests the cloud print server 10 to transmit the multifunction peripheral list and the restriction information associated with the logged-in user (step S232). However, the network communication cannot be performed normally here, which disables the transmission of a transmission request to the cloud print server 10. When the communication processing unit 21 detects this communication abnormality, the control unit 25 shifts the PC a to the local print mode (step S233). In this manner, the local print mode control unit 24 becomes the operation entity in the PC a.

Since the PC a is not able to currently acquire the multifunction peripheral list, the multifunction peripheral list display part 241 reads out, from the multifunction peripheral list storage unit 27, a latest multifunction peripheral list at this time point, that is, the multifunction peripheral list acquired at the time of the last login, and displays the multifunction peripheral list (step S234). The user selects, from the displayed multifunction peripheral list, a multifunction peripheral 40 as a print destination of a file without using the cloud print service. Upon receiving the multifunction peripheral 40 selected by the user (step S235), the control information processing part 243 transmits a control information transmission request to each multifunction peripheral 40 (step S236). The multifunction peripheral 40 as a transmission destination may be each multifunction peripheral 40 set in the multifunction peripheral list. It is assumed here that the multifunction peripherals 40 set in the multifunction peripheral list are the multifunction peripheral a and the multifunction peripheral b, and that the user has selected the multifunction peripheral a as a print destination.

The multifunction peripherals 40 that have received the control information transmission request, that is, the multifunction peripherals a and b, each read out restriction information stored in the restriction information storage unit 45 thereof, and transmit the restriction information to the PC a as a transmission requesting source (step S432).

Upon acquiring the restriction information from each of the multifunction peripherals a and b as transmission request destinations, the control information processing part 243 refers to the received restriction information and the update date and time associated with the user in the restriction information stored in the PC a, and selects the latest restriction information (step S237). In this manner, it is possible to identify the printable number of sheets updated by the latest print processing executed by the PC a and the multifunction peripherals a and b. Once the latest restriction information is identified, the control information processing part 243 updates the restriction information storage unit 28 with the identified restriction information (step S238). Then, the control information processing part 243 notifies each of the multifunction peripherals a and b of the latest restriction information (step S239). In this manner, each of the multifunction peripherals a and b is able to update the restriction information stored therein with the latest restriction information (step S433).

While in the present exemplary embodiment, all the multifunction peripherals a and b are notified of the latest restriction information, such restriction information may not be transmitted to the multifunction peripheral 40 that already holds the latest restriction information because the update of the restriction information is not necessary.

Subsequently, the user selects a file to be printed from files stored in the file storage unit 26. Upon acquiring the file selected by the user (step S240), the print instruction part 244 generates a print job for printing the file, and transmits a print execution instruction to the multifunction peripheral a received at step S235 (step S241).

The print execution part 423 of the multifunction peripheral a executes the print job transmitted from the PC a (step S434). Here, similarly to the case of the normal print mode, every time one page is printed, the print execution part 423 notifies the restriction information management unit 43 of such printing. Every time the restriction information management unit 43 receives the notification in response to the execution of printing of one page, the restriction information management unit 43 updates the printable number of sheets in the restriction information associated with the user, which is set in the restriction information storage unit 45, to be subtracted by one. In this manner, even in a state where the access to the restriction information managed by the cloud print server 10 is not possible, it is possible to update the restriction information while maintaining the consistency of the restriction information between the PC 20 and the multifunction peripheral 40.

Thereafter, once the multifunction peripheral 40 becomes able to access the cloud print server 10 in response to network recovery, the communication processing unit 41 detects the accessible state to confirm the network recovery (step S435). In the local print mode, the communication processing unit 41 may periodically access the cloud print server 10 to monitor the network connection state, or may receive a notification from another device. In any case, it is possible to detect the recovery of the network to a normal state before the restriction information in the cloud print server 10 is accessed, for example, at the timing of acquiring a job list in accordance with user's operation (step S412), which makes the monitoring of the network connection state dispensable.

When the connection of the network is confirmed, the restriction information management unit 43 transmits the restriction information of the user set in the restriction information storage unit 45 to the cloud print server 10 (step S436).

In accordance with the notification from the multifunction peripheral a, the restriction information management unit 13 in the cloud print server 10 updates the restriction information of the user set in the restriction information storage unit 16 (step S131). In this manner, it is possible to reflect the print result, that is, the printable number of sheets updated by print processing executed in the local print mode, that is, in a state where the cloud print server 10 is not able to access the PC 20 and the multifunction peripheral 40. Therefore, the restriction information managed by the cloud print server 10 can be updated after network recovery.

In the exemplary embodiment, in a case where the restriction on the use of the multifunction peripheral 40 is managed by the cloud print server 10, even if printing is executed in a state where the PC 20 and the multifunction peripheral 40 are not able to access the cloud print server 10, it is possible to prevent an inconvenience from occurring in the use of the multifunction peripheral 40.

As the predetermined timing at which the PC 20 and the multifunction peripheral 40 acquire the restriction information from the cloud print server 10, there have been exemplified various cases such as the time of user login or the time of acquiring various kinds of information. Needless to say, the restriction information may be acquired at such a timing, while it may be repeatedly acquired from the cloud print server 10, for example, periodically, so that the restriction information stored in each of the PC 20 and the multifunction peripheral 40 is constantly maintained in the latest state.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The present disclosure is also applicable to a program and a program product.

### APPENDIX

(((1)))
   An information processing system, comprising:
   a first processor included in each of one or more processing execution apparatuses configured to execute processing in accordance with an instruction from a user;
   a second processor included in each of one or more information processing apparatuses to be used when the user instructs the one or more processing execution apparatuses to execute processing; and
   a third processor included in an information management apparatus configured to manage restriction information related to a restriction on a use of the one or more processing execution apparatuses by the user, wherein
   the first processor and the second processor are each configured to acquire the restriction information from the information management apparatus at a predetermined timing and respectively cause a corresponding processing execution apparatus among the one or more processing execution apparatuses and a corresponding information processing apparatus among the one or more information processing apparatuses to hold the restriction information, and
   the second processor is configured to:
      acquire the restriction information held by each of the one or more processing execution apparatuses when the information management apparatus is not accessible in accordance with an operation of the user; and
      cause the restriction information held by the corresponding information processing apparatus and by each of the one or more processing execution apparatuses to be updated with latest restriction information selected from the restriction information held by the corresponding information processing apparatus and the restriction information acquired from each of the one or more processing execution apparatuses.
(((2)))
The information processing system according to (((1))), wherein the second processor is configured to acquire the restriction information from the information management apparatus when an application to be used for instructing the one or more processing execution apparatuses to execute processing is activated, as the predetermined timing.
(((3)))
   The information processing system according to (((1))) or (((2))), wherein the second processor is configured to, in a case where a job used for executing processing in the one or more processing execution apparatuses is preregistered in the information management apparatus, acquire the restriction information from the information management apparatus when processing of preregistering the job is executed, as the predetermined timing.
(((4)))
   The information processing system according to (((3))), wherein the first processor is configured to acquire the restriction information from the information management apparatus when the job is acquired from the information management apparatus, as the predetermined timing.
(((5)))
   The information processing system according to any one of (((1))) to (((4)))), wherein
   the second processor is configured to
   update the restriction information held by the corresponding information processing apparatus and by each of the one or more processing execution apparatuses with the latest restriction information, and then transmit an execution instruction of processing to a processing execution apparatus among the one or more processing execution apparatuses in accordance with an instruction from the user, and
   the first processor is configured to
   start execution of the processing in accordance with the execution instruction from the corresponding information processing apparatus, and update, in response to the execution of the processing, the restriction information held by the processing execution apparatus.
(((6)))
   The information processing system according to (((5))), wherein the first processor is configured to, in response to confirming that the information management apparatus is accessible after finishing the execution of the processing, transmit the restriction information held by the processing execution apparatus to the information management apparatus so as to update the restriction information managed by the information management apparatus.
(((7)))
   An information processing apparatus to be included in an information processing system together with one or more processing execution apparatuses and an information management apparatus, the one or more processing execution apparatuses being configured to execute processing in accordance with an instruction from a user, the information processing apparatus being used when the user instructs the one or more processing execution apparatuses to execute processing, the information management apparatus being configured to manage restriction information related to a restriction on a use of the one or more processing execution apparatuses by the user, the information processing apparatus comprising:
   a processor configured to:
   acquire the restriction information from the information management apparatus at a predetermined timing and cause the information processing apparatus to hold the restriction information;
   acquire the restriction information held by each of the one or more processing execution apparatuses when the information management apparatus is not accessible in accordance with an operation of the user; and
   cause the restriction information held by the information processing apparatus and by each of the one or more processing execution apparatuses to be updated with latest restriction information selected from the restriction information held by the information processing apparatus and the restriction information acquired from each of the one or more processing execution apparatuses.
(((8)))
   A program causing, in an information processing system including one or more processing execution apparatuses configured to execute processing in accordance with an instruction from a user, one or more information processing apparatuses to be used when the user instructs the one or more processing execution apparatuses to execute processing, and an information management apparatus configured to manage restriction information related to a restriction on a use of the one or more processing execution apparatuses by the user, a computer of each of the one or more processing execution apparatuses and a computer of each of the one or more information processing apparatuses to execute a process comprising:
   by the computer of each of the one or more processing execution apparatuses and the computer of each of the one or more information processing apparatuses, acquiring the restriction information from the information management apparatus at a predetermined timing and respectively causing a corresponding processing execution apparatus among the one or more processing execution apparatuses and a corresponding information processing apparatus among the one or more information processing apparatuses to hold the restriction information; and
   by the computer of each of the one or more information processing apparatuses,
acquiring the restriction information held by each of the one or more processing execution apparatuses when the information management apparatus is not accessible in accordance with an operation of the user, and
   causing the restriction information held by the corresponding information processing apparatus and each of the one or more processing execution apparatuses to be updated with latest restriction information selected from the restriction information held by the corresponding information processing apparatus and the restriction information acquired from each of the one or more processing execution apparatuses.

What is claimed is:

1. An information processing system, comprising:
a first processor included in each of one or more processing execution apparatuses configured to execute processing in accordance with an instruction from a user;
a second processor included in each of one or more information processing apparatuses to be used when the user instructs the one or more processing execution apparatuses to execute processing; and
a third processor included in an information management apparatus configured to manage restriction information related to a restriction on a use of the one or more processing execution apparatuses by the user, wherein
the first processor and the second processor are each configured to acquire the restriction information from the information management apparatus at a predetermined timing and respectively cause a corresponding processing execution apparatus among the one or more processing execution apparatuses and a corresponding information processing apparatus among the one or more information processing apparatuses to hold the restriction information, and
the second processor is configured to:
acquire the restriction information held by each of the one or more processing execution apparatuses when the information management apparatus is not accessible in accordance with an operation of the user; and
cause the restriction information held by the corresponding information processing apparatus and by each of the one or more processing execution apparatuses to be updated with latest restriction information selected from the restriction information held by the corresponding information processing apparatus and the restriction information acquired from each of the one or more processing execution apparatuses.

2. The information processing system according to claim 1, wherein the second processor is configured to acquire the restriction information from the information management apparatus when an application to be used for instructing the one or more processing execution apparatuses to execute processing is activated, as the predetermined timing.

3. The information processing system according to claim 1, wherein the second processor is configured to, in a case where a job used for executing processing in the one or more processing execution apparatuses is preregistered in the information management apparatus, acquire the restriction information from the information management apparatus when processing of preregistering the job is executed, as the predetermined timing.

4. The information processing system according to claim 3, wherein the first processor is configured to acquire the restriction information from the information management apparatus when the job is acquired from the information management apparatus, as the predetermined timing.

5. The information processing system according to claim 1, wherein
the second processor is configured to
update the restriction information held by the corresponding information processing apparatus and by each of the one or more processing execution apparatuses with the latest restriction information, and then transmit an execution instruction of processing to a processing execution apparatus among the one or more processing execution apparatuses in accordance with an instruction from the user, and
the first processor is configured to
start execution of the processing in accordance with the execution instruction from the corresponding information processing apparatus, and update, in response to the execution of the processing, the restriction information held by the processing execution apparatus.

6. The information processing system according to claim 5, wherein the first processor is configured to, in response to confirming that the information management apparatus is accessible after finishing the execution of the processing, transmit the restriction information held by the processing execution apparatus to the information management apparatus so as to update the restriction information managed by the information management apparatus.

7. An information processing apparatus to be included in an information processing system together with one or more processing execution apparatuses and an information management apparatus, the one or more processing execution apparatuses being configured to execute processing in accordance with an instruction from a user, the information processing apparatus being used when the user instructs the one or more processing execution apparatuses to execute processing, the information management apparatus being configured to manage restriction information related to a restriction on a use of the one or more processing execution apparatuses by the user, the information processing apparatus comprising:
a processor configured to:
acquire the restriction information from the information management apparatus at a predetermined timing and cause the information processing apparatus to hold the restriction information;
acquire the restriction information held by each of the one or more processing execution apparatuses when the information management apparatus is not accessible in accordance with an operation of the user; and
cause the restriction information held by the information processing apparatus and by each of the one or more processing execution apparatuses to be updated with latest restriction information selected from the restriction information held by the information processing apparatus and the restriction information acquired from each of the one or more processing execution apparatuses.

8. A non-transitory computer readable medium storing a program causing, in an information processing system including one or more processing execution apparatuses configured to execute processing in accordance with an instruction from a user, one or more information processing apparatuses to be used when the user instructs the one or more processing execution apparatuses to execute processing, and an information management apparatus configured to manage restriction information related to a restriction on a use of the one or more processing execution apparatuses by the user, a computer of each of the one or more processing execution apparatuses and a computer of each of the one or more information processing apparatuses to execute a process comprising:
by the computer of each of the one or more processing execution apparatuses and the computer of each of the one or more information processing apparatuses, acquiring the restriction information from the information management apparatus at a predetermined timing and respectively causing a corresponding processing execution apparatus among the one or more processing execution apparatuses and a corresponding information processing apparatus among the one or more information processing apparatuses to hold the restriction information; and
by the computer of each of the one or more information processing apparatuses,
acquiring the restriction information held by each of the one or more processing execution apparatuses when the information management apparatus is not accessible in accordance with an operation of the user, and
causing the restriction information held by the corresponding information processing apparatus and each of the one or more processing execution apparatuses to be updated with latest restriction information selected from the restriction information held by the corresponding information processing apparatus and the restriction information acquired from each of the one or more processing execution apparatuses.
